(19) United States
(12) Patent Application Publication
(10) Pub. No.: US 2023/0260015 A1
(43) Pub. Date: Aug. 17, 2023

(54) RENTAL SPACE MANAGEMENT SYSTEM

(71) Applicant: TAISHO SKY BUILDING, INC., Tokyo (JP)

(72) Inventor: Kazuharu ISHIDA, Tokyo (JP)

(21) Appl. No.: 18/301,323

(22) Filed: Apr. 17, 2023

Related U.S. Application Data
(63) Continuation of application No. PCT/JP2020/043389, filed on Nov. 20, 2020.

(51) Int. Cl. G06Q 30/0645; G06Q 10/02; G06Q 30/04; G06Q 30/0235

(52) U.S. Cl. CPC G06Q 30/0645; G06Q 10/02; G06Q 30/04; G06Q 30/0235

(57) ABSTRACT

A rental space management system that can operate a rental space unattended and improve user satisfaction, wherein a rental space management system includes a management server that manages a room and an image capturing unit that monitors a state of the room. The management server includes a state monitor, an original state restoration determiner, and a determination result annunciator. The state monitor causes the image capturing unit to monitor the state of the room. The original state restoration determiner determines whether original state restoration of the room is required by comparing a state at the start of use and a state at the end of use of the room monitored by the state monitor. When the original state restoration determiner determines that the original state restoration is required, the determination result annunciator announces the determination result of the original state restoration determiner to an administrator of the room.

### RELATED APPLICATIONS

The present application is a continuation of International Patent Application No. PCT/JP2020/043389, filed Nov. 20, 2020, which is hereby incorporated by reference in its entirety.

### TECHNICAL FIELD

The present disclosure relates to a rental space management system.

### BACKGROUND

Systems for renting an empty conference room of a building, an office, a hotel, or the like to general users may include a management server open to a communication network such as the Internet and a plurality of reservation servers in which information on the conference room is stored. A user can access the information on the conference room in the reservation server via the management server to reserve a desired conference room. In addition, the rental system also has a billing function so that a rental fee can be paid online.

When renting such a rental space to the general users, after using the rental space, it is necessary to carry out indoor cleaning of the rental space and original state restoration such as restoring an arrangement of equipment such as desks and chairs installed in the rental space, for the next user.

However, although it is possible to reserve and pay for the rental space, an administrator of the rental space must check an inside of the rental space by oneself and decide whether to perform the original state restoration, and if the rental space is to be operated unattended, there is a problem that the satisfaction level of the user is lowered.

### SUMMARY

An object of the present disclosure is to provide a rental space management system that can operate the rental space unattended without requiring the presence of the administrator and improve user satisfaction.

A rental space management system of the present disclosure is a rental space management system including a management server that manages a rental space and a user input unit that is connected to the management server via a communication line and receives information input to the management server, the rental space management system including a state monitoring unit that monitors a state of the rental space, in which the management server includes: a reservation information setter that stores and sets reservation information, that is received via the user input unit and is related to a user of the rental space and reservation date and time set by reservation, in a storage; a state monitor that causes the state monitoring unit to monitor the state of the rental space; an original state restoration determiner that determines whether original state restoration of the rental space is required by comparing a state at the start of use and a state at the end of use of the rental space monitored by the state monitor; and a determination result annunciator that announces a determination result of the original state restoration determiner and information on a user who has used the rental space during a usage time that has been compared by the original state restoration determiner, to an administrator of the rental space, when the original state restoration determiner determines that the original state restoration is required.

With such a configuration, the management server includes the determination result annunciator that announces the determination result of the original state restoration determiner and the information on the user who has used the rental space during the usage time that has been compared by the original state restoration determiner, to an administrator of the rental space, when the original state restoration determiner determines that the original state restoration is required, so that the administrator can carry out indoor cleaning of the rental space and original state restoration such as restoring the arrangement of equipment such as desks and chairs installed in the rental space, for the next user, on the basis of the content announced by the determination result annunciator. Therefore, the rental space management system can operate the rental space unattended without requiring the presence of the administrator, and improve user satisfaction.

In the present disclosure, the management server preferably includes a cost billing part that charges cost of the original state restoration to the user who has used the rental space during the usage time that has been compared by the original state restoration determiner, when the original state restoration determiner determines that the original state restoration is required.

With such a configuration, since the management server includes the cost billing part, when the original state restoration determiner determines that the original state restoration is required, the management server can automatically charge the cost of the original state restoration to the user who has used the rental space during the usage time that has been compared by the original state restoration determiner.

In the present disclosure, the management server preferably includes a discount billing part that charges a user who uses the rental space after the usage time that has been compared by the original state restoration determiner by discounting a usage fee of the rental space, when the original state restoration determiner determines that the original state restoration is required.

With such a configuration, since the management server includes the discount billing part, when the original state restoration determiner determines that the original state restoration is required, the management server can charge the user who uses the rental space after the usage time that has been compared by the original state restoration determiner by discounting the usage fee of the rental space, and suppress dissatisfaction of the next user.

In the present disclosure, when the original state restoration determiner determines that the original state restoration is required, the determination result annunciator preferably announces the determination result of the original state restoration determiner to an original state restorer of the rental space.

With such a configuration, when the original state restoration determiner determines that the original state restoration is required, the determination result annunciator announces the determination result of the original state restoration determiner to the original state restorer of the rental space, so that the original state restorer of the rental space can properly perform the original state restoration of the rental space.

In the present disclosure, when the determination result annunciator announces the determination result of the original state restoration determiner to the original state restorer of the rental space, the determination result annunciator preferably creates work contents for performing the original state restoration, and announces the work contents to the original state restorer.

With such a configuration, since the determination result annunciator creates the work contents for performing the original state restoration, and announces the work contents to the original state restorer, the administrator does not have to newly announce the work contents for performing the original state restoration to the original state restorer, and a burden on the administrator can be reduced.

In the present disclosure, when the determination result annunciator announces the determination result of the original state restoration determiner to the original state restorer of the rental space, the determination result annunciator preferably orders a work for the original state restoration to the original state restorer of the rental space.

With such a configuration, since the determination result annunciator orders the work for the original state restoration to the original state restorer of the rental space, the administrator does not have to newly order the work for the original state restoration to the original state restorer, and the burden on the administrator can be reduced.

In the present disclosure, it is preferred that when the original state restoration determiner determines whether the original state restoration of the rental space has been performed, and determines that the original state restoration of the rental space has been performed, the original state restoration determiner pays cost of the original state restoration to the original state restorer of the rental space.

With such a configuration, when the original state restoration determiner determines whether the original state restoration of the rental space has been performed, and determines that the original state restoration of the rental space has been performed, the original state restoration determiner pays the cost of the original state restoration to the original state restorer of the rental space, so that the administrator does not have to check whether the original state restoration of the rental space has been performed, or pay the cost of the original state restoration, and the burden on the administrator can be reduced.

### BRIEF DESCRIPTION OF THE DRAWINGS

FIG. 1 is a schematic configuration diagram of a rental space management system according to an embodiment of the present disclosure.

FIG. 2 is a functional block diagram illustrating a schematic configuration of the rental space management system.

FIG. 3 is a flowchart illustrating an operation of the rental space management system.

### DETAILED DESCRIPTION

Hereinafter, an embodiment of the present disclosure will be described with reference to the drawings.

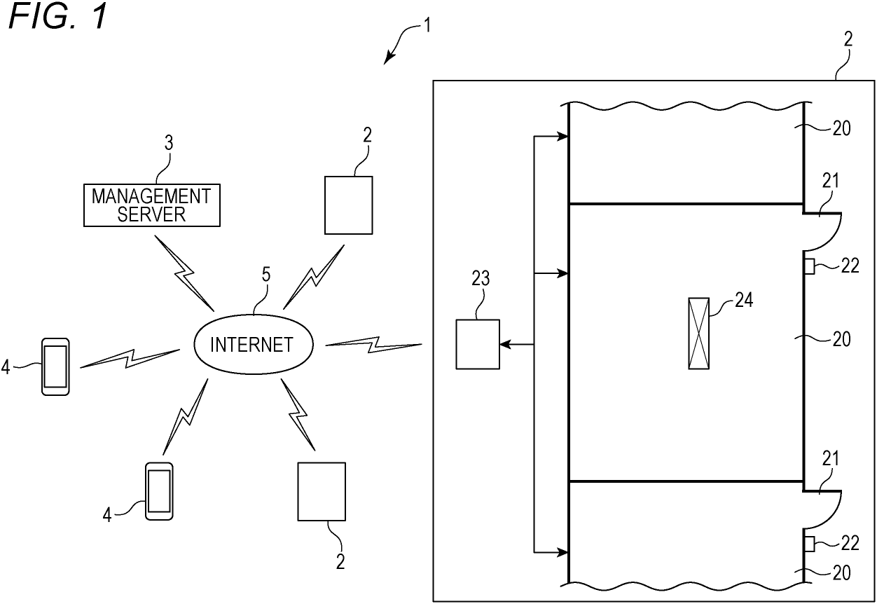

FIG. 1 is a schematic configuration diagram of a rental space management system according to the embodiment of the present disclosure.

As illustrated in FIG. 1, a rental space management system 1 includes a building 2, a management server 3 that manages the building 2, and a terminal device 4 as a user input unit such as a mobile phone, a smartphone, and a personal computer owned by a user who wishes to use the building 2. The building 2, the management server 3, and the terminal device 4 are connected to each other so as to be able to communicate with each other via the Internet 5, which is a public network as a communication line.

The building 2 includes a plurality of rooms 20 (rental spaces), and each room 20 includes a doorway 21 and a locking device 22 for locking and unlocking the doorway 21. The locking device 22 can be unlocked by an unlocking key such as a password or an optical code such as a bar code or a QR code (registered trademark) issued from the management server 3 to the terminal device 4 of the user. This unlocking key is randomly changed each time it is used, and the user who makes a reservation for that time can unlock the locking device 22 by using a unique unlocking key.

Note that in the present embodiment, the password, or the optical code such as the bar code or the QR code (registered trademark) is employed as the unlocking key, but for example, biometric authentication such as face authentication, fingerprint authentication, or retinal authentication may be employed, and any unlocking key may be employed as long as it can unlock the locking device 22.

Each room 20 includes a communication terminal device 23 such as a modem or a router connected via a local area network (LAN), and an image capturing unit 24 for capturing an image of an inside of the room 20. The communication terminal device 23 and the image capturing unit 24 are connected to the management server 3 via the Internet 5. As the image capturing unit 24, for example, a charge coupled device (CCD) camera or the like can be employed.

The user can access the management server 3 via the Internet 5 using the terminal device 4, search for the room 20 desired to be used, specify a usage time, and make a reservation for the room 20.

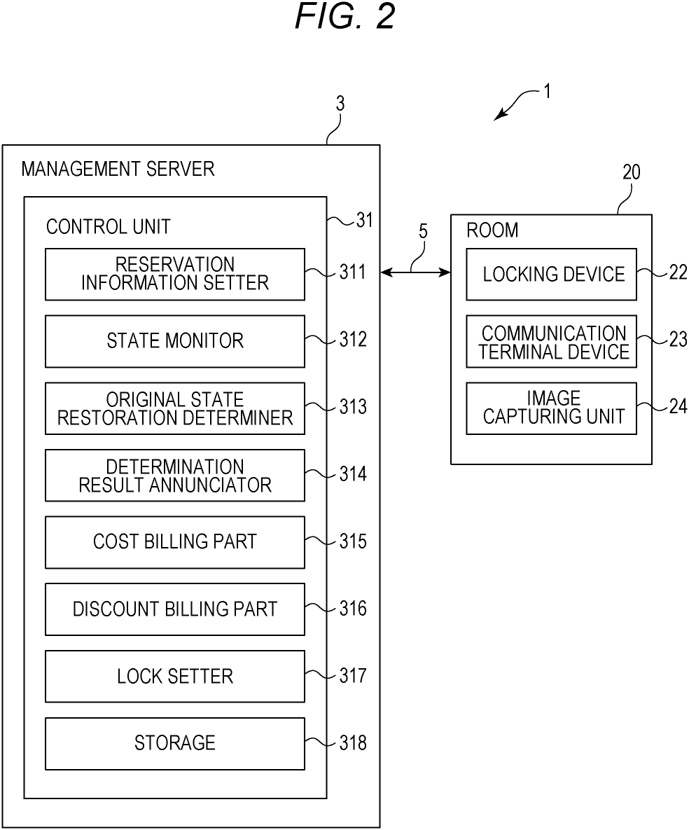

FIG. 2 is a functional block diagram illustrating the schematic configuration of the rental space management system.

As illustrated in FIG. 2, the management server 3 includes a control unit 31.

The control unit 31 includes a CPU, a memory, and the like, and executes information processing according to a predetermined program stored in the memory. The control unit 31 includes a reservation information setter 311, a state monitor 312, an original state restoration determiner 313, a determination result annunciator 314, a cost billing part 315, a discount billing part 316, and a lock setter 317, and a storage 318.

The reservation information setter 311 stores and sets reservation information, that is received via the terminal device 4 and is related to the user of the room 20 and reservation date and time (usage start time and usage end time) set by reservation, in the storage 318.

The state monitor 312 causes the image capturing unit 24 to monitor a state of the room 20. Specifically, the state monitor 312 captures a state at the start of use and a state at the end of use of the room 20 with the image capturing unit 24, to obtain image data, and stores the image data in the storage 318. As described above, in the present embodiment, the image capturing unit 24 functions as a state monitoring unit.

Note that in the present embodiment, the image capturing unit 24 is employed as the state monitoring unit, but any state monitoring unit may be employed as long as it can monitor the state of the room 20. For example, the state monitoring unit may be a sensor for detecting an arrangement of equipment such as desks and chairs installed in the room 20, a sensor for detecting dirt on a floor surface of the room 20, or a sensor for detecting odor of the room 20. In short, the state monitoring unit is only required to be able to monitor the state of the room 20.

The original state restoration determiner 313 determines whether the room 20 needs to be restored to an original state by comparing the state at the start of use and the state at the end of use of the room 20 monitored by the state monitor 312. Specifically, the original state restoration determiner 313 compares the dirt in the room 20 and the arrangement of the equipment such as desks and chairs installed in the room 20 on the basis of two image data of the state at the start of use and the state at the end of use of the room 20 stored in the storage 318. Then, when the original state restoration determiner 313 detects the dirt in the room 20 or a change in the arrangement of the equipment such as desks and chairs installed in the room 20, it determines that original state restoration of the room 20 is required, and when the original state restoration determiner 313 does not detect the dirt and the change in the arrangement, it determines that the original state restoration of the room 20 is not required.

When the original state restoration determiner 313 determines that the original state restoration is required, the determination result annunciator 314 announces a determination result of the original state restoration determiner 313 and information on the user who has used the room 20 during a usage time that has been compared by the original state restoration determiner 313, to an administrator of the room 20.

Further, when the original state restoration determiner 313 determines that the original state restoration is required, the determination result annunciator 314 announces the determination result of the original state restoration determiner 313 to an original state restorer of the room 20.

Here, when the determination result annunciator 314 announces the determination result of the original state restoration determiner 313 to the original state restorer of the room 20, it may also create work contents for performing the original state restoration and announce the work contents together.

For example, when the original state restoration determiner 313 detects the dirt in the room 20, the determination result annunciator 314 may announce the work contents of requesting the cleaning to remove the dirt in the room 20 to the original state restorer of the room 20, and when the original state restoration determiner 313 detects the change in the arrangement of the equipment such as desks and chairs installed in the room 20, the determination result annunciator 314 may announce the work contents of restoring the arrangement of the equipment such as desks and chairs installed in the room 20 to the original state restorer of the room 20, or may announce a plurality of work contents together.

Note that the building 2 may be configured to include various maintenance devices such as a robot vacuum cleaner for cleaning a floor of the room 20, an air conditioning device for ventilating and air conditioning the room 20, and a deodorizing device for deodorizing the room 20, and the maintenance devices may be configured to be controlled by the control unit 31. In this configuration, when the original state restoration determiner 313 determines that the original state restoration is required, the control unit 31 determines whether the original state can be restored by the various maintenance devices, and when it determines that the original state can be restored, it performs the original state restoration by the various maintenance devices, and when it determines that the original state cannot be restored, it may create the work contents for performing the original state restoration, and announce the work contents to the original state restorer of the room 20, as described above. Further, when the original state restoration determiner 313 determines that the original state restoration is required, the control unit 31 may perform a part of the original state restoration by the various maintenance devices, create the work contents for performing the rest of the original state restoration, and announce the work contents to the original state restorer of the room 20.

Further, the determination result annunciator 314 may announce the work contents for performing the original state restoration, and request the original state restorer of the room 20 to estimate the time required for the work for the original state restoration, the work contents, the work man hours, and the like. Further, the determination result annunciator 314 may announce the work contents for performing the original state restoration, and order the work for the original state restoration to the original state restorer of the room 20.

Note that the contents of the original state restoration are not only the cleaning to remove the dirt in the room 20 and the work contents of restoring the arrangement of the equipment such as desks and chairs installed in the room 20, but also replenishment of the equipment in the room 20 and the work contents of replacement or repair for failure or damage of equipment such as gas and water. Then, the determination result annunciator 314 may be configured to automatically select an original state restorer such as a cleaning company or a repair company necessary for the original state restoration from a plurality of original state restoration companies on the basis of the contents and cost of the original state restoration.

Then, after the original state restorer of the room 20 restores the room 20 to the original state, the original state restoration determiner 313 may determine whether the original state restoration of the room 20 has been performed by comparing the state of the room 20 monitored by the state monitor 312 at the start of use and the state of the room 20 monitored by the state monitor 312 after the original state restoration again. Then, when the original state restoration determiner 313 determines that the original state restoration of the room 20 has been performed, it may pay the cost of the original state restoration to the original state restorer of the room 20.

When the original state restoration determiner 313 determines that the original state restoration is required, the cost billing unit 315 charges the user, who used the room 20 during the usage time that has been compared by the original state restoration determiner 313, for the cost of the original state restoration on the basis of the reservation information stored in the storage 318.

When the original state restoration determiner 313 determines that the original state restoration is required, the discount billing part 316 charges the user, who uses the room 20 after the usage time that has been compared by the original state restoration determiner 313, by discounting a usage fee of the room 20 on the basis of the reservation information stored in the storage 318.

The lock setter 317 sets the locking device 22 of the room 20.

Specifically, when the usage start time included in the reservation information is reached (or it may be shortly before the usage start time (for example, 10 minutes before the usage start time)), the lock setter 317 sets the unlocking key corresponding to the reservation information to the locking device 22 of the room 20.

Further, when the usage end time included in the reservation information has passed (or it may be shortly after the usage end time (for example, 10 minutes after the usage end time)), the lock setter 317 resets an unlocking key different from the unlocking key corresponding to the reservation information to the locking device 22 of the room 20.

Note that the storage 318 includes the memory of the control unit 31, but may include an HDD, a NAS, or the like, or may include a cloud service.

Further, although each function of the control unit 31 is executed according to the program stored in the storage 318, each function may be configured by an independent device or may be configured by cloud computing.

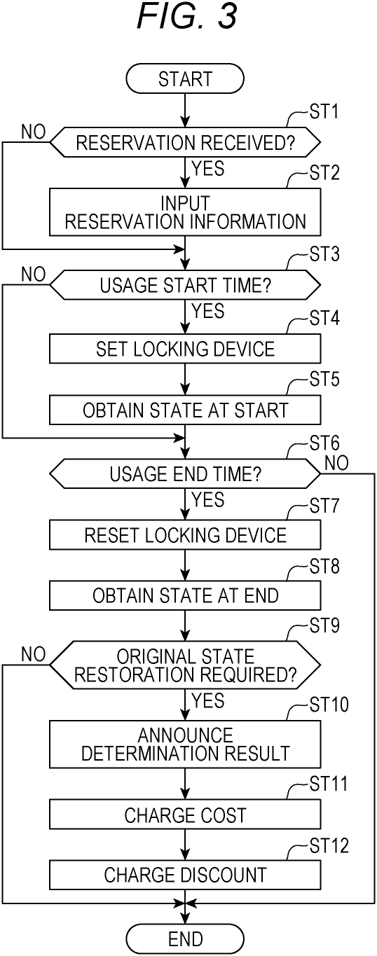

FIG. 3 is a flowchart illustrating an operation of the rental space management system.

As illustrated in FIG. 3, the control unit 31 of the management server 3 repeatedly executes various processing of Steps ST1 to ST12 at predetermined time intervals according to the predetermined program stored in the memory.

As described above, the user of the room 20 can access the management server 3 via the Internet 5 using the terminal device 4, search for the room 20 desired to be used, specify the usage time, and make the reservation for the room 20.

The reservation information setter 311 of the management server 3 determines whether the reservation from the user has been received (Step ST1).

When the reservation information setter 311 determines that the reservation from the user is not received, processing after Step ST3 is executed.

On the other hand, when the reservation information setter 311 determines that the reservation from the user has been received, the reservation information setter 311 inputs, stores and sets the reservation information including the user and the reservation date and time of the room 20 for which the reservation has been confirmed to the storage 318 (Step ST2).

After executing the processing of Step ST2, or when it is determined in Step ST1 that the reservation from the user is not received, the control unit 31 determines whether it is the usage start time of the room 20 included in the reservation information stored in the storage 318 (Step ST3).

When it is determined in Step ST3 that the usage start time of the room 20 has not been reached, the control unit 31 executes the processing after Step ST6.

On the other hand, when it is determined in Step ST3 that the usage start time of the room 20 has been reached, the lock setter 317 sets the unlocking key corresponding to the reservation information stored in the storage 318 to the locking device 22 of the room 20 (Step ST4). Thus, the user can unlock the locking device 22 of the room 20 by using the unlocking key transmitted from the management server 3 and enter the room 20.

After executing the processing of Step ST4, the state monitor 312 causes the image capturing unit 24 to monitor the state of the room 20, to capture an image of the state at the usage start time of the room 20 and obtain the image data, and causes the storage 318 to store the image data (Step ST5).

After executing the processing of Step ST5, or when it is determined in Step ST3 that the usage start time of the room 20 has not been reached, the control unit 31 determines whether it is the usage end time of the room 20 included in the reservation information stored in the storage 318 (Step ST6).

When it is determined in Step ST6 that the usage end time of the room 20 has not been reached, the control unit 31 ends the various processing.

On the other hand, when it is determined in Step ST6 that the usage end time of the room 20 has been reached, the lock setter 317 resets an unlocking key different from the unlocking key corresponding to the reservation information stored in the storage unit 318 to the locking device 22 of the room 20 (Step ST7). Thus, the user cannot re-enter the room 20.

After executing the processing of Step ST7, the state monitor 312 causes the image capturing unit 24 to monitor the state of the room 20, to capture an image of the state at the usage end time of the room 20 and obtain the image data, and causes the storage 318 to store the image data (Step ST8).

After executing the processing of Step ST8, the original state restoration determiner 313 determines whether the original state restoration of the room 20 is required by comparing the state at the start of use and the state at the end of use of the room 20 monitored by the state monitor 312 (Step ST9).

When it is determined in Step ST9 that the original state restoration of the room 20 is not required, the control unit 31 ends the various processing.

On the other hand, when it is determined in Step ST9 that the original state restoration of the room 20 is required, the determination result annunciator 314 announces the determination result of the original state restoration determiner 313 and the information on the user who has used the room 20 during the usage time that has been compared by the original state restoration determiner 313, to the administrator of the room 20 on the basis of the reservation information stored in the storage 318. Further, the determination result annunciator 314 announces the determination result of the original state restoration determiner 313 to the original state restorer of the room 20 (Step ST10).

After executing the processing of Step ST10, the cost billing part 315 charges the cost of the original state restoration to the user who has used the room 20 during the usage time that has been compared by the original state restoration determiner 313 on the basis of the reservation information stored in the storage 318 (Step ST11).

After executing the processing of Step ST11, the discount billing part 316 charges the user, who uses the room 20 after the usage time that has been compared by the original state restoration determiner 313, by discounting the usage fee of the room 20 on the basis of the reservation information stored in the storage 318 (Step ST12).

After executing the processing of Step ST12, the control unit 31 ends the various processing.

According to such an embodiment, the following operations and effects can be obtained.

(1) The management server 3 includes the determination result annunciator 314 that announces the determination result of the original state restoration determiner 313 and the information on the user who has used the room 20 during the usage time that has been compared by the original state restoration determiner 313, to the administrator of the room 20, when the original state restoration determiner 313 determines that the original state restoration is required, so that the administrator can carry out the indoor cleaning of the room 20 and the original state restoration such as restoring the arrangement of the equipment such as desks and chairs installed in the room 20, for the next user, on the basis of the content announced by the determination result annunciator 314. Therefore, the rental space management system 1 can operate the room 20 unattended without requiring the presence of the administrator, and improve user satisfaction.

(2) Since the management server 3 includes the cost billing part 315, when the original state restoration determiner 313 determines that the original state restoration is required, the management server 3 can automatically charge the cost of the original state restoration to the user who has used the room 20 during the usage time that has been compared by the original state restoration determiner 313.

(3) Since the management server 3 includes the discount billing part 316, when the original state restoration determiner 313 determines that the original state restoration is required, the management server 3 can charge the user who uses the room 20 after the usage time that has been compared by the original state restoration determiner 313 by discounting the usage fee of the room 20, and can suppress dissatisfaction of the next user.

(4) When the original state restoration determiner 313 determines that the original state restoration is required, the determination result annunciator 314 announces the determination result of the original state restoration determiner 313 to the original state restorer of the room 20, so that the original state restorer of the room 20 can appropriately perform the original state restoration of the room 20.

(5) Since the determination result annunciator 314 creates the work contents for performing the original state restoration, and announces the work contents to the original state restorer, the administrator does not have to newly announce the work contents for performing the original state restoration to the original state restorer, and a burden on the administrator can be reduced.

(6) Since the determination result annunciator 314 orders the work for the original state restoration to the original state restorer of the room 20, the administrator does not have to newly orders the work for the original state restoration to the original state restorer, and the burden on the administrator can be reduced.

(7) When the original state restoration determiner 313 determines whether the original state restoration of the room 20 has been performed, and determines that the original state restoration of the room 20 has been performed, the original state restoration determiner 313 pays the cost of the original state restoration to the original state restorer of the room 20, so that the administrator does not have to check whether the original state restoration of the room 20 has been performed, or pay the cost of the original state restoration, and the burden on the administrator can be reduced.

### Modification of Embodiment

Note that the present disclosure is not limited to the above embodiment, and modifications, improvements, and the like within a range in which an object of the present disclosure can be achieved are included in the present disclosure.

For example, in the above embodiment, the management server 3 may be configured by a centralized management type server device or may be a distributed management type, for example, a device using a distributed transaction ledger typified by blockchain can be used.

In the above embodiment, the management server 3 includes the cost billing part 315, and when the original state restoration determiner 313 determines that the original state restoration is required, the management server 3 automatically charges the cost of the original state restoration to the user who has used the room 20 during the usage time that has been compared by the original state restoration determiner 313. On the other hand, the management server 3 does not have to include the cost billing part 315, and in this case, the administrator takes appropriate measures for the user who has used the room 20 during the usage time that has been compared by the original state restoration determiner 313, on the basis of the contents announced by the determination result annunciator 314.

In the above embodiment, the management server 3 includes the discount billing part 316, and when the original state restoration determiner 313 determines that the original state restoration is required, the management server 3 charges the user who uses the room 20 after the usage time that has been compared by the original state restoration determiner 313 by discounting the usage fee of the room 20. On the other hand, the management server 3 does not have to include the discount billing part 316, and in this case, the administrator takes appropriate measures for the user who uses the room 20 after the usage time that has been compared by the original state restoration determiner 313, on the basis of the contents announced by the determination result annunciator 314.

In the above embodiment, when the original state restoration determiner 313 determines that the original state restoration is required, the determination result annunciator 314 announces the determination result of the original state restoration determiner 313 to the original state restorer of the room 20, but the determination result annunciator 314 does not have to announce the determination result to the original state restorer of the room 20. In short, when the original state restoration determiner 313 determines that the original state restoration is required, the determination result annunciator 314 is only required to announce the determination result of the original state restoration determiner 313 and the information on the user who has used the room 20 during the usage time that has been compared by the original state restoration determiner 313, to the administrator of the room 20.

1. A rental space management system including a management server that manages a rental space and a user input means that is connected to the management server via a communication line and receives information input to the management server, the rental space management system comprising
a state monitoring means that monitors a state of the rental space, wherein
the management server comprises:
a reservation information setter that stores and sets reservation information, that is received via the user input means and is related to a user of the rental space and reservation date and time set by reservation, in a storage;
a state monitor that causes the state monitoring means to monitor the state of the rental space;
an original state restoration determiner that determines whether original state restoration of the rental space is required by comparing a state at the start of use and a state at the end of use of the rental space monitored by the state monitor; and
a determination result annunciator that announces a determination result of the original state restoration determiner and information on a user who has used the rental space during a usage time that has been compared by the original state restoration determiner, to an administrator of the rental space, when the original state restoration determiner determines that the original state restoration is required.

2. The rental space management system according to claim 1, wherein the management server comprises a cost billing part that charges cost of the original state restoration to the user who has used the rental space during the usage time that has been compared by the original state restoration determiner, when the original state restoration determiner determines that the original state restoration is required.

3. The rental space management system according to claim 1, wherein the management server comprises a discount billing part that charges a user who uses the rental space after the usage time that has been compared by the original state restoration determiner by discounting a usage fee of the rental space, when the original state restoration determiner determines that the original state restoration is required.

4. The rental space management system according to claim 1, wherein when the original state restoration determiner determines that the original state restoration is required, the determination result annunciator announces the determination result of the original state restoration determiner to an original state restorer of the rental space.

5. The rental space management system according to claim 4, wherein when the determination result annunciator announces the determination result of the original state restoration determiner to the original state restorer of the rental space, the determination result annunciator creates work contents for performing the original state restoration, and announces the work contents to the original state restorer.

6. The rental space management system according to claim 4, wherein when the determination result annunciator announces the determination result of the original state restoration determiner to the original state restorer of the rental space, the determination result annunciator orders a work for the original state restoration to the original state restorer of the rental space.

7. The rental space management system according to claim 4, wherein when the original state restoration determiner determines whether the original state restoration of the rental space has been performed, and determines that the original state restoration of the rental space has been performed, the original state restoration determiner pays cost of the original state restoration to the original state restorer of the rental space.
